(19) United States
(12) Patent Application Publication
(10) Pub. No.: US 2006/0094853 A1
(43) Pub. Date: May 4, 2006

(54) Modified phenol-formaldehyde resole resins, methods of manufacture, methods of use, and articles formed therefrom

(75) Inventor: Stephen W. Arbuckle, Louisville, KY (US)

Correspondence Address: RESOLUTION PERFORMANCE PRODUCTS LLC;ATTN: LISA JONES, 1600 SMITH STREET, P.O. BOX 4500, HOUSTON, TX, 77210-4500, US

(73) Assignee: Hexion Specialty Chemicals, Inc.

(21) Appl. No.: 11/264,925

(22) Filed: Nov. 1, 2005

Related U.S. Application Data
(60) Provisional application No. 60/624,229, filed on Nov. 2, 2004.

(51) Int. Cl. C08G 8/02

(52) U.S. Cl. 528/128

(57) ABSTRACT

A method for the manufacture of a modified phenolic-aldehyde resin composition, comprises reacting a base with a phenolic compound to produce a phenolate medium; adding an aldehyde source to the phenolate medium wherein the initial mole ratio of aldehyde to phenolic compound is about 0.7:1 to about 1.4:1; heating the aldehyde source and phenolate medium for a time and at a temperature sufficient to yield an aldehyde-phenolate medium with a level of free aldehyde of less than about 0.5% of the total mass on a liquids basis; adding a urea-aldehyde condensate to the aldehyde-phenolate medium; and condensing the resulting urea-aldehyde-phenolate medium, wherein the modified phenolic-aldehyde resin composition is not infinitely dilutable in water. A modified phenolic-aldehyde resin prepared by this method is also disclosed, as are articles prepared therewith.

### RELATED APPLICATION DATA

This application claims the benefit of U.S. Provisional Application Ser. No. 60/624,229 filed Nov. 2, 2004, the entire contents of which are hereby incorporated by reference.

### BACKGROUND

This disclosure relates to phenol-formaldehyde resole resins, their preparation, use, and articles formed therefrom.

Phenol-formaldehyde resole resins are of utility in a wide range of applications due to their excellent physical properties, including their durability, water resistance, bond strength, and the like, as well as their low cost and ease of manufacture and use. Phenol-formaldehyde resole resins have accordingly been used in the manufacture of laminates and consolidated wood products such as plywood and engineered lumber, particle board, fiber board, and oriented strand board, as well as in products such as fiberglass insulation, abrasive coatings, friction binders, foams, foundry binders, and petroleum recovery binders. They are also used as paper saturating resins for oil filters, overlay, paint roller tubes, and the like.

While a wide variety of phenol-formaldehyde resole resins have been developed and are suitable for their intended purposes, environmental and industry standards demand ever-increasing improvement in both environmental compliance and physical properties of the resins. Reduction in formaldehyde emissions has proved particularly difficult without significantly adversely affects the advantageous properties of the resins, cost, and/or manufacturing time. For example, formaldehyde scavengers such as urea, ammonia, melamine, various primary and secondary amines, dicyandiamide, and other amino-based modifications have been added to resoles. These are typically post-added to the resin at the resin manufacturers' or at the customers' plant, resulting in low efficiencies. Post-addition of urea can cause trimethylamine odors, which arises from incomplete reaction of urea. Post-addition of ammonia as a scavenger can lead to lower water dilutability, unwanted precure, and ammonia odor.

Other approaches include post-addition of a cyclic urea prepolymer, as described in U.S. Pat. No. 6,114,491. This prepolymer is formed from and contains ammonia. A process of reacting a first amino-based scavenger under acidic conditions and a second amino-based scavenger at neutral or slightly basic conditions is described in U.S. Pat. No. 4,757,108. A process requiring adding ammonia, specifically at the site of the resin manufacturer, before the addition of urea, is described in U.S. Pat. No. 5,300,562.

There accordingly remains a need in the art for compositions and methods that will lower aldehyde (specifically formaldehyde) emissions from phenol-formaldehyde resole resins while maintaining or improving stability, cure efficiency, and/or advantageous physical properties such as durability, water resistance, and or bond strength.

The most common commercial scavengers are chemical species containing a primary or secondary amine functionality, for example urea, ammonia, melamine, and dicyandiamide

There also remains a particular need in the art for improved phenol-formaldehyde resole resins for use as plywood and engineered lumber adhesives. Urea has been added to plywood and engineered lumber resins and adhesives to improve pre-press tack, bond quality, cost, assembly time tolerance, and reduce formaldehyde emissions, generally in amounts of up to about 5 wt %, based on the solid weight of urea to the total resin weight (at 41% solids, including the urea). However, when urea is used at higher levels, the phenol-formaldehyde resole resin may require a long assembly time (time between application of the adhesive and when the panels are hot pressed or pre-pressed), to eliminate dryout of the adhesive.

A need also exists with respect to particle board, for example oriented strand board (OSB). Spray dried oriented strand boards (OSB) and wafer board resins are very sensitive to any extender or filler that is used in the resin. Many attempts have been made to use small amounts of urea or urea-formaldehyde resins as extenders in various phenol-formaldehyde and phenol-melamine-formaldehyde resins, but is has been found that the urea may interfere with the ability of the resin to be spray dried, and/or adversely affect durability. Urea in these applications is thus typically limited to 1 wt %, for the purpose of scavenging free formaldehyde.

Phenol-formaldehyde resole resins are also used to manufacture high pressure laminates. Laminates that are post-formed (thermoformed) into more complex shapes after the pressing process is complete may require a less brittle resin. Brittle laminates also tend to chip and break when they are cut to size or machined prior to use or can be more breakage prone during installation and use. This is also unacceptable to the consumer. Another drawback in the laminating industry is the release of volatile organic components into the atmosphere during the B-staging process, including formaldehyde and phenol. Typical levels of free phenol in the phenol-formaldehyde resole resin used to impregnate the kraft core paper are about 5 to about 15 wt %. One method to reduce the free phenol level in the base phenol-formaldehyde resole resin is to increase the amount of formaldehyde (relative to the phenol) in the resin as manufactured. Unfortunately this can result in a more brittle resin that when cured is unacceptable for manufacturing postforming laminates. There accordingly remains a need for resins that can be used in the manufacture of paper laminates that have low phenol and formaldehyde emissions and that are not brittle upon cure.

### SUMMARY OF THE INVENTION

The above-described drawbacks and disadvantages of the prior art are alleviated by a phenol-formaldehyde resole resin modified with a urea-aldehyde condensate, referred to herein as a modified phenolic-aldehyde resin.

In an embodiment, a method for the manufacture of a modified phenolic-aldehyde resin composition, comprises reacting a base with a phenolic compound to produce a phenolate medium; adding an aldehyde source to the phenolate medium wherein the initial mole ratio of aldehyde to phenolic compound is about 0.7:1 to about 1.4:1; heating the aldehyde source and phenolate medium for a time and at a temperature sufficient to yield an aldehyde-phenolate medium with a level of free aldehyde of less than about 0.5% of the total mass on a liquids basis; adding a urea-aldehyde condensate to the aldehyde-phenolate medium; and condensing the resulting urea-aldehyde-phenolate medium, wherein the modified phenolic-aldehyde resin composition is not infinitely dilutable in water.

In another embodiment, a modified phenolic-aldehyde resin comprises the reaction product of the combination of: a phenolic compound; about 0.01 to about 0.1 moles of base catalyst per mole of phenolic compound; an aldehyde, wherein the initial molar ratio of aldehyde:phenolic compound is about 0.7:1 to about 1.4:1; and a urea-aldehyde condensate, the combination being reacted at a temperature of about 70 to about 90° C. for a time effective to form a modified phenolic-aldehyde resin that is not infinitely dilutable in water, and wherein the final molar ratio of aldehyde:phenolic compound in the modified phenolic-aldehyde resin is about 0.7:1 to about 4.5:1.

In another embodiment, a composition comprises an additive and a modified phenolic-aldehyde resin composition comprising the reaction product of the combination of: a phenolic compound; about 0.01 to about 1.0 moles of base catalyst per mole of phenolic compound; an aldehyde, wherein the molar ratio of aldehyde:phenolic compound is about 0.7:1 to about 1.4:1; and a urea-aldehyde condensate, the combination being reacted at a temperature of about 70 to about 90° C. for a time effective to form a modified phenolic-aldehyde resin that is not infinitely dilutable in water.

### DETAILED DESCRIPTION OF THE INVENTION

This invention describes the manufacture of a modified phenolic-aldehyde resin that has low free formaldehyde content. By introduction of a urea-formaldehyde condensate to a phenol-formaldehyde resole resin, a product can be made that has low free formaldehyde content at manufacture and during storage, and that emits low formaldehyde levels during processing and curing. In particular, stable modified phenolic-aldehyde resins having excellent physical properties and reduced emissions may be prepared by addition of a urea-aldehyde condensate during formation and/or use of the phenol-formaldehyde resole resin. The resins are not infinitely dilutable in water, but have good solution stability under storage conditions at high solids.

As used herein, the term “condensate” refers to the condensation product of urea and an aldehyde, and may be used interchangeably with the term “urea-aldehyde condensate”; the terms “urea-formaldehyde concentrate” and “UF concentrate” are used to describe the specific condensate of urea and formaldehyde, and may be used interchangeably; the term “phenol-formaldehyde resole resin” refers to the base catalyzed reaction product of a hydroxy aromatic compound and an aldehyde, and which may contain co-reactants such as urea or dicyandiamide, but which does not comprise urea-aldehyde concentrate; the term “modified phenolic-aldehyde resin” refers to the reaction product of the resole resin (with or without co-reactants) and a urea-aldehyde condensate; the term “modified phenolic-aldehyde resin composition” refers to a liquid reaction product comprising the modified phenolic-aldehyde resin; the terms “premix” and “premix composition”, where used, refer to the combination (in solution) of a resole resin or modified phenolic-aldehyde resin with added urea, and may be used interchangeably; and the term “manufacturing composition”, refers to the combination of a modified phenolic-aldehyde resin with other additives such as, for example, plasticizer, filler, and thermal acid generators.

The urea-aldehyde condensate is formed by the reaction of urea and a reactive aldehyde source under alkaline conditions. The urea may be derived from a variety of commercially available forms, for example solid urea, such as prill, and aqueous urea solutions. Reactive aldehydes such as formaldehyde, mixtures comprising formaldehyde, or other sources of formaldehyde, are specifically useful. Formaldehyde may be used in the form of a gas, a formalin solution (an aqueous solution of formaldehyde) in typical concentrations of about 37 to about 60 wt % (weight %), as paraformaldehyde (solid, polymerized formaldehyde), or as a mixture comprising any of the foregoing. Reactive aldehydes can also be substituted in whole or in part for formaldehyde to produce the aqueous urea-aldehyde condensate. Examples of other reactive aldehydes that may be used include acetaldehyde, propionaldehyde, furfuraldehyde, glutaraldehyde, and benzaldehyde. Mixtures comprising at least one of the foregoing may also be used. The aldehyde is typically used in an amount of about 4 to about 6 moles per mole of urea, with an optimum dependent on the particular application. In one embodiment, an example of the urea-formaldehyde condensate has a formaldehyde-to-urea ratio of about 3:1 to about 6:1, preferably about 4:1 to about 6:1 and more preferably about 5:1.

The relative amounts of aldehyde, urea, and water used to form the urea-aldehyde condensate and effective times and temperature for reaction will depend on the desired concentrations of formaldehyde, urea-aldehyde condensate, and water in the urea-aldehyde condensate. These relative ratios will in turn depend on the type of phenol-formaldehyde resole resins used and the desired end properties of the resin. In general, the urea-aldehyde condensate may comprise about 0.1 to about 50 wt %, specifically about 10 to about 30 wt %, more specifically about 20 to about 25 wt % free formaldehyde; about 20 to about 90 wt %, specifically about 50 to about 75 wt %, mores specifically about 60 to about 65 wt % urea-formaldehyde; and about 5 to about 60 wt %, specifically about 8 to about 35 wt %, more specifically about 12 to about 18 wt % water.

In one embodiment, the urea-aldehyde condensate comprises urea, formaldehyde, and water, and is a urea-formaldehyde condensate. A particular example is where the urea-formaldehyde condensate comprises about 60 wt % formaldehyde, about 25 wt % urea, and about 15 wt % water. In another example, the condensate comprises about 50 wt % formaldehyde, about 21 wt % urea, and about 29 wt % water. In another example, the urea-formaldehyde condensate comprises about 65 wt % formaldehyde, about 25 wt % urea, and about 10 wt % water. It will be appreciated by those skilled in the art that the formaldehyde content of the composition is distributed at least between formaldehyde reacted with the urea to form methylol groups, and free formaldehyde. The distribution ratio of these forms of the formaldehyde will be influenced by the ratios of formaldehyde, urea, and water, and additionally by reaction time, temperature, processing conditions such as the use of a vacuum strip or reflux, and concentration. A typical amount of free formaldehyde for a single embodiment may be about 15 wt % to about 30 wt % of the urea-aldehyde condensate, specifically about 20 wt % to about 25 wt %. It will also be appreciated by one skilled in the art that additional variations of the ratio of formaldehyde, urea, and water, as well as variations in reaction conditions as described above, may be used, which will provide a urea-aldehyde condensate that acts within the scope of the present disclosure.

In general, these urea-aldehyde condensates may be obtained by mixing about 20 to about 80 wt %, specifically about 30 to about 70 weight percent, more specifically about 50 to about 65 wt % formaldehyde, about 5 to about 70 wt %, specifically about 15 to about 50 weight percent, mores specifically about 20 to about 40 wt % urea, and about 0.01 to about 1.0 wt %, specifically about 0.02 to about 0.5 weight percent, more specifically about 0.03 to about 0.4 wt % catalytic base at a temperature of about 40 to about 100° C., specifically about 75 to about 85° C. if processing in batch mode, for about 3 to about 10 hours depending on process.

The urea-aldehyde condensates may be prepared in a container such as a laboratory flask or plant reactor. Additionally, urea-formaldehyde condensate may be prepared using a continuous flow process. Such a process may comprise adding gaseous formaldehyde, 50 wt % urea in aqueous medium, and a base catalyst to an absorber column. Water may be removed from the condensate during this process. Such urea-formaldehyde condensates may also be obtained commercially. An example of a suitable composition is Casco® UF85 concentrate from Hexion Specialty Chemicals, Inc., formerly known as Borden Chemical.

An example of the preparation of a urea-formaldehyde condensate is as follows: A flask is charged with 124.5 g of a 50 wt % solution of formaldehyde, and the temperature of the solution is raised to about 60 to about 70° C. The formaldehyde solution is adjusted to a pH of about 8.5 to about 9.2 by addition of about 0.7 g of 50 wt % sodium hydroxide in water. About 25 g of urea is then added, and the temperature is slowly raised to about 78 to about 82° C., and the temperature of the reaction is maintained at about 80° C. for a hold time of about 30 minutes. During this hold, the pH is checked about every 10 minutes, and is adjusted to maintain a reaction pH of about 7.2 or greater by addition of an effective amount of 25 wt % sodium hydroxide. After the hold time, the reaction is cooled to about 45° C. Water is distilled off the reaction to a refractive index endpoint for the resulting condensate of about 1.469 to about 1.472, where it is desirable to approach the higher number in the event that it is necessary to add formaldehyde. Using the above proportions, the amount of distillate removed, which gives this refractive index endpoint, is about 52.4 g. The amount of free formaldehyde is determined by using the sodium sulfite method and is adjusted to about 20 to about 25 wt %, more specifically about 21 to about 23 wt % by further addition of formaldehyde.

The urea-aldehyde condensate is used with a phenol-formaldehyde resole resin to form the modified phenolic-aldehyde resin. Phenol-formaldehyde resole resins may be prepared by the reaction of a hydroxy-functional aromatic compound (hereinafter “phenolic compound”), for example phenol, with an aldehyde or aldehyde condensate, for example formaldehyde, under alkaline reaction conditions. Examples of aldehydes for this purpose are in part described above, where these aldehydes may be suitable for use in the formation of either or both of the urea-aldehyde condensate and the phenolic-aldehyde resole resin. For convenience, all such phenolic-aldehyde resins may be referred to herein as “phenol-formaldehyde resole resins.” It is to be understood that while the terms “phenol” and “formaldehyde” may be used in the following description for convenience, the discussion also applies to other hydroxy-functional aromatic compounds, reactive aldehydes, and mixtures as described herein. Thus, other hydroxy-functional aromatic compounds including monophenolic and dihydric phenolic compounds can be used, or used in addition to phenol itself. Examples of substituted monophenols that can be used include alkyl-substituted monophenols such as o-cresol, m-cresol, p-cresol, 3,5-xylenol, 3,4-xylenol, 3,4,5-trimethyl phenol, 3-ethyl phenol, 3,5-diethyl phenol, p-butyl phenol, 3,5-dibutyl phenol, p-amyl phenol, p-octyl phenol, and the like; cycloalkyl-substituted monophenols such as p-cyclohexyl phenol, 3,5-dicyclohexyl phenol, and the like; alkenyl-substituted monophenols; aryl-substituted monophenols such as p-phenyl phenol; alkoxy-substituted monophenols such as 3,5-dimethyoxyphenol, p-ethoxy phenol, p-butoxy phenol, 3,4,5-trimethoxyphenol, and the like; aryloxy-substituted monophenols such as p-phenoxy phenol; halogen-substituted monophenols such as p-chlorophenol; and polycyclic monophenols such as naphthol, anthranol, and substituted derivatives thereof. Similarly, dihydric phenols such as catechol, resorcinol, hydroquinone, bisphenol A and bisphenol F can be used. Mixtures comprising at least one of the foregoing hydroxy-functional aromatic compounds may be used. Phenol itself is specifically useful, as well as mixtures which include phenol.

Similarly, other reactive aldehydes as described above can be substituted in whole or in part for formaldehyde to produce the formaldehyde resole resin. Formaldehyde or mixtures comprising formaldehyde are specifically useful. The formaldehyde may be used in the form of a gas, a formalin solution (an aqueous solution of formaldehyde, with typical concentrations of about 37 to about 60 wt % of formaldehyde), and/or paraform (paraformaldehyde, or solid, polymerized formaldehyde).

Additionally, nitrogenous compounds with crosslinkable functional sites may be used either in combination with the hydroxy-functionalized aromatic compounds described above. Examples of such nitrogenous compounds with a suitable reactivity include amines such as ethylenediamine, propylenediamine, 1,3-pentanediamine, 1,4-butanediamine, 1,5-pentanediamine, 1,6-hexanediamine, bis-(2-aminoethyloxy)ethylene, melamine, urea, dicyandiamide, and cyclic ureas such as ethyleneurea, propyleneurea, trimethyleneurea, and glycoluril. Urea, dicyandiamide, or melamine are useful, as well as mixtures which include urea, dicyandiamide, and melamine.

Alkaline reaction conditions may be established by adding an alkaline catalyst to an aqueous solution of the phenol and/or phenol and formaldehyde reactants. Suitable alkaline catalysts include those known in the art for the manufacture of resole resins, and include, for example, alkali and/or alkaline earth metal hydroxides such as lithium hydroxide, sodium hydroxide and potassium hydroxide; alkaline earth metal oxides such as lime; alkali metal carbonates such as sodium carbonate and potassium carbonate; and certain amines. Based on considerations of cost and availability, sodium hydroxide and/or potassium hydroxide is used most often.

Effective amounts of alkaline catalyst are known to those skilled in the art. Typically, at least about 0.005 mol of alkaline catalyst per mol of phenol is used, specifically an amount between about 0.01 and about 1 mol of alkaline catalyst per mol of phenol, depending on the application. All of the catalyst can be added initially to the phenol and the formaldehyde provided it is added slowly to control the exothermic reaction, or the catalyst can be added incrementally in two or more additions or continuously over a defined time period. It is normally recommended that the catalyst be added in three to five or more additions to maintain control of the reaction. Use of a relatively high level of catalyst may reduce residual monomers and simultaneously minimize the proportion of high molecular weight species in the product. For example, the amount of catalyst may be about 0.01 mol to about 0.60 mol, specifically about 0.02 mol to about 0.20 mol of catalyst per mol of phenolic compound.

In one embodiment, as a typical process for the manufacture of phenol-formaldehyde resole resins, an initial aqueous reaction mixture may be prepared by first combining a hydroxy-functional aromatic compound and a basic polymerization catalyst in an aqueous solution to provide a phenolate medium. The reactive aldehyde is then added to the phenolate medium (also referred to herein as the “initial aqueous reaction mixture”). Alternatively, the initial aqueous reaction mixture may be prepared by mixing a hydroxy-functional aromatic compound and a reactive aldehyde, followed by addition of a basic polymerization catalyst. In an advantageous aspect to the process, the initial ratio of aldehyde to phenolic compound is kept low, to push the equilibrium of the reaction to a greater degree of conversion of the initial aldehyde charge. A useful initial molar ratio of aldehyde to phenolic compound for this purpose is about 0.7:1 to about 1.4:1, more specifically about 0.9:1 to about 1.2:1. One skilled in the art will appreciate that a molar excess of phenol will encourage lower free formaldehyde content, thereby obviating the need for addition of an aldehyde scavenger. One skilled in the art will further appreciate that a desired stoichiometry is in part also defined as the presence of equivalent molar concentrations in the reaction medium at a given instant in time, and may be affected by other factors such as heat, reaction time, and removal of by-products from the reaction which would affect the equilibrium of the reaction. In light of these constraints, it is within the skill of a practitioner in the art to determine the appropriate ratio of aldehyde to phenolic compound for a particular application, and to select the appropriate reaction conditions.

Use of a more limited formaldehyde charge in the initial stage of the polymerization defers the introduction of additional aldehyde, which may be useful in building the desired properties of the resin, to a later stage. A source of additional aldehyde may be an additional charge of the aldehyde itself, of a self-condensate such as paraformaldehyde, or of a condensate with an additional component such as a condensate of urea and formaldehyde.

After completion of the addition of the aldehyde, the temperature of the phenolate medium is maintained within a range effective to complete methylolation and effect condensation, until a predetermined endpoint is achieved. The temperature is desirably maintained sufficiently high so that the condensation reaction can occur rapidly, without significant buildup of molecular weight. The temperature of the first aqueous reaction mixture may, for example, be maintained at about 50 to about 100° C.; more specifically at about 65 to about 95° C.; still more specifically at about 75 to about 85° C.

The endpoint can be determined by an analytical technique that samples the extent of condensation, for example gel permeation chromatography (GPC) or water tolerance. The endpoint is predetermined based on the desired properties of the resulting phenol-formaldehyde resole resin, and is generally chosen so as to simultaneously minimize the residual free monomer content of the resin while maximizing the ability to achieve the desired molecular weight in consideration of such properties as paper penetration, cure time, application techniques other such parameters. The endpoint can be determined by an analytical technique that samples the extent of condensation, for example gel permeation chromatography (GPC).

The urea-aldehyde condensate may be combined with the phenol-formaldehyde resole resin at any point during, after, or both during and after the process of manufacture and used as described in more detail below. The point in the process for addition of the urea-aldehyde condensate is dependent upon the amount of formaldehyde present in the phenol-formaldehyde resole resin, on the amount of the urea-aldehyde condensate to be added, and is considered in view of the desired molecular weight of the final resin and the amount of free monomer desired. It is within the skill of one versed in the art to determine the appropriate point of introduction of the condensate.

In one embodiment, the urea-aldehyde condensate is added when the predetermined endpoint is reached. Adding the urea-aldehyde condensate has several advantages over adding solid urea and formaldehyde solution. For example, the urea-aldehyde condensate is a more concentrated source of formaldehyde. Commercially available formaldehyde solutions typically contain about 50% formaldehyde by weight versus the about 60% by weight contained in the material. The additional formaldehyde gives the final modified phenolic-aldehyde resin product the reactivity and polymer crosslink density desired to produce laminate with acceptable properties (i.e., water resistance, formability, and impact resistance). In addition, because the urea is added in a pre-reacted form with formaldehyde prior to addition to the phenol-formaldehyde resole resin, and where there is essentially no unreacted urea, a high urea content is obtained in the final resin product without compromising resin performance in the end application. Since urea is a low cost component, there is commercial advantage in urea-modified phenol-formaldehyde resole resins (i.e., modified phenolic-aldehyde resins) that perform similarly to unmodified phenol-formaldehyde resole resins. Since less water is added to the reaction mixture, less is required to be removed by distillation. Additionally, the polymerization reactions proceed more readily.

In another embodiment, the urea-aldehyde condensate is added when the residual free aldehyde content of the reaction is less than about 0.5 wt %, specifically less than about 0.2 wt %, more specifically less than about 0.1 wt %, still more specifically less than about 0.05 wt %, and still more specifically less than about 0.01 wt %. In addition, the residual free aldehyde content is greater than about 0.01 ppm, specifically greater than about 0.1 ppm, more specifically greater than about 1 ppm, still more specifically greater than about 5 ppm, and still more specifically greater than about 10 ppm. This procedure results in resins having very a low free formaldehyde value, therefore reducing the formaldehyde emissions, without the use of aldehyde scavengers.

The amount of urea-aldehyde condensate added to the phenol-formaldehyde resole resin will depend on the types and ratios of starting materials, as well as the desired properties of the final modified phenolic-aldehyde resin. Typical amounts may be about 0.1 to about 30 wt %, specifically about 1 to about 20 wt %, more specifically about 5 to about 15 wt %, as based on the wet resin. During and after addition of the urea-aldehyde condensate, the reaction is continued at a temperature and for a time effective to blend and/or further condense the resin and the condensate. Effective temperature and times will depend upon the types and ratios of starting materials, as well as the desired resin properties. In general, this portion of the process may be conducted about 50 to about 100° C., specifically about 75 to about 85° C., for about 5 minutes to about 4 hours, specifically about 30 minutes to about 3 hours, more specifically about 60 to about 150 minutes.

The final aldehyde ratio in the modified phenolic-aldehyde resin after combination of the phenol-formaldehyde resole resin and the urea-aldehyde condensate is about 0.7 to about 4.5 moles of the aldehyde per mole of phenolic compound (i.e., 0.7:1 to 4.5:1), more specifically about 0.7 to about 2.5 moles of the aldehyde per mole of phenolic compound (i.e., 0.7:1 to 2.5:1) in the modified phenolic-aldehyde resin, but with the optimal ranges being dependent on the particular application. As used herein, “overall formaldehyde to phenol ratio” describes the ratio of formaldehyde to phenol present after modification of the phenol-formaldehyde resole resin with the urea-aldehyde concentrate, and is also referred to herein as the “final formaldehyde to phenol ratio”. In an example of one embodiment, a phenol-formaldehyde resole resin wherein the ratio of formaldehyde to phenol is about 1.1:1 is combined with a urea-formaldehyde condensate wherein the ratio of formaldehyde to urea is about 4.8:1, in proportions sufficient to produce an overall (i.e., final) formaldehyde to phenol ratio of about 1.425:1 in the resulting modified phenolic-aldehyde resin. In this instance, the amount of formaldehyde added as a condensate with urea is about 0.325 moles per mole of phenol in the phenol-formaldehyde resole resin.

Once preparation of the phenol-formaldehyde resole resin as modified with urea-aldehyde condensate (i.e., the modified phenolic-aldehyde resin) is complete, additional components may be added to adjust the desired properties of the modified phenolic-aldehyde resin. Specifically, and in view of the high conversion of the components of the modified phenolic-aldehyde resin, a compatible plasticizing additive may be combined with the modified phenolic-aldehyde resin to provide desirable melt-flow characteristics to the manufacturing compositions prepared from the modified phenolic-aldehyde resin. Suitable plasticizers for use in the manufacturing compositions may be compatible with the modified phenolic-aldehyde resin, and may have low phase separation tendency and relatively high vapor pressure to mitigate emissions during subsequent processing. Suitable plasticizers may also have relatively low reactivity under the reaction conditions present between the introduction of the plasticizer to form the manufacturing compositions (the A staged resin) and the end-use high temperature and pressure cure of the manufacturing composition comprising the modified phenolic-aldehyde resin (the C staged resin). A desired property of the plasticizer is that it only condense with the manufacturing composition matrix under the end use conditions in forming an article, and retain flow and permeability properties during processing of the precure (also referred to herein as the “B” stage) of the resin. Examples of suitable plasticizers include, but are not limited to, gum rosins, alcohols, ethylene glycol and oligomeric derivatives, propylene glycols and oligomeric derivatives, diethylene glycol, propylene glycol, 1,3-propane diol, glycerol, sorbitol, sugars, sugar alcohols, phenolic pot residues such as bisphenol A (BPA) and bisphenol F (BPF), low molecular weight phenolic compound-aldehyde novolaks, and soluble oligomers of phenolic compounds, which may undergo only limited reaction prior to final cure at the C stage. A plasticizer may be added at about 0.1 to about 15 wt %, more specifically about 1 to about 5 wt %, of the total solids charge.

A plasticizer, if added, may be dispersed in the matrix and allowed to react in the presence of suitable concentrations of reactive co-condensing monomer, such as an aldehyde, or it may be added and permitted to disperse without co-condensing. Specifically, the aldehyde may comprise formaldehyde. Any condensation an aldehyde, such as formaldehyde, and a plasticizer may be limited by the concentration of the most reactive species. In one embodiment, a plasticizer is added to a modified phenolic-aldehyde resin composition medium. Dispersion of the plasticizer may be aided by heating the resulting composition from about 25 to about 100° C., specifically about 50 to about 75° C., for about 1 minute to about 1 hour, more specifically about 5 minutes to about 20 minutes depending on the plasticizer.

A distillation step may be included, to adjust the solids content of the modified phenolic-aldehyde resin. Distillation is run for a time sufficient to collect about 10 to about 25% by weight, more specifically about 15 to about 18% by weight of the total mass charged, under conditions of about 45 to about 100° C., specifically about 50 to about 85° C., and at about 633 to about 5 torr (about 5 to about 29.8 inches Hg of vacuum), more specifically about 379 to about 72.5 torr (about 15 to about 27 inches Hg of vacuum).

Once preparation of the modified phenolic-aldehyde resin composition is complete, the mixture is cooled, for example to a temperature of about 20 to about 50° C. Other additives may be included in the modified phenolic-aldehyde resin composition, such as a solution viscosity modifier or neutralizing acid. Suitable solution viscosity modifiers are low molecular weight solvents miscible with the modified phenolic-aldehyde resin composition medium, and include lower alcohols. Examples of suitable lower alcohols include methanol, ethanol, propanol, butanol, pentanol, t-butanol, sec-butanol, isopropanol, isobutanol, and the like. A specifically useful lower alcohol is methanol. The alcohol is added in an amount sufficient to achieve a viscosity in the modified phenolic-aldehyde resin composition of about 80 to about 20,000 centipoise (cPs), specifically about 80 to about 400 cPs for typical applications. Acid may be added until a pH of about 5.5 to about 10 is achieved, to neutralize the modified phenolic-aldehyde resin composition for storage and handling and application requirements for cure. The cooled mixture may be acidified using a strong acid such as sulfamic acid, sulfuric acid, formic acid, acetic acid, boric acid, phosphoric acid, lactic acid and the like, and mixtures thereof. Salts of the foregoing acids may also be used.

The mixture is further cooled, for example to a temperature of about 15 to about 30° C. The modified phenolic-aldehyde resin composition, which may be an aqueous composition, can be used directly, or packaged, as by drumming, and stored until needed or transferred to a site of intended use. Storage conditions are about 12 to about 22° C., and are similar to the conditions for resins that are not so modified. Desirably, the modified phenolic-aldehyde resins are not infinitely dilutable in water (wherein “infinitely dilutable” means dilutable to a ratio of greater than about 50 parts water to about 1 part resin without evidence of precipitation of the resin), but maintain their solution stability during shipping and storage at high solids (typically about 50 to about 70% solids). Additionally, the higher solids compositions can be delivered at lower freight costs to the customer. Other advantages include less water is required to be removed by distillation since less water is added to the reaction mixture and the polymerization reaction proceeds more readily at higher solids.

The resulting modified phenolic-aldehyde resin composition can be used to prepare a manufacturing composition or adhesive for a variety of applications. To make the completed manufacturing composition or adhesive composition, other additives, such as a catalyst, latent cure catalyst, or other additives such as filler, plasticizer, blowing agent, colorant, mold release agent, or the like, can be added to the modified phenolic-aldehyde resin composition. Latent catalysts neutralize the alkalinity of the modified phenolic-aldehyde resin upon heating and lower the pH to give an acid cure. Typical amounts are at least about 2 wt %, specifically about 4 to about 10 wt %, based on the weight of manufacturing composition solids. Suitable latent catalysts include ammonium sulfate and the like. Such components may be added to the mixture of modified phenolic-aldehyde resin composition shortly before use. The manufacturing composition may then be contacted to a substrate material. Such substrate materials may be cellulosic, where common cellulosic materials include, but are not limited to paper, wood, wood flour, cotton, other vegetable fibers, coconut husk, ground nut shells, and the like. One application for the modified phenolic-aldehyde resins described above is in the manufacture of paper laminates. Typical overall molar ratios of formaldehyde to phenol in such modified phenolic-aldehyde resins may be about 0.9 to about 2.5 moles of formaldehyde per mole of phenol, specifically about 1.2 to about 1.9 moles of formaldehyde per mole of phenol. Suitable catalyst levels are about 0.2 to about 12 wt %, specifically about 0.5 to about 4 wt %. These materials may be used as synthesized, or an organic solvent such as methanol can be added to reduce the percent solids and viscosity and aid in penetration of the kraft paper substrate.

Laminates may be made from several layers of paper that have been impregnated with thermosetting resins such as a modified phenolic-aldehyde resin as described hereinabove, dried (B-staged), and then cured under pressure in a heated press. The surface of the laminate is made from a decorative paper (a solid color or printed with a pattern) that is impregnated with a melamine-formaldehyde resin. Underneath this surface are several layers of kraft paper that are impregnated with the above-described modified phenolic-aldehyde resin, and which function as a core for the laminate. The amount of modified phenolic-aldehyde resin solids incorporated into these papers varies from about 30 to about 80% based on the weight of the total laminate, and typically depends on the type of application and the type of materials used to make the laminate.

Both the resin impregnated decorative paper and the resin impregnated kraft core paper are passed through ovens to increase the molecular weight of the modified phenolic-aldehyde resin component, and reduce the volatile level in the sheet (B-staging). After B-staging, a decorative sheet is laid up with several layers of the kraft core paper and loaded into a press. The press is brought up to pressure, typically 1000 psi, when making high-pressure laminate and then heated up to temperatures typically ranging from about 120 to about 160° C. for about 20 to about 60 minutes. Such lamination consolidates the multiple paper layers and cures the modified phenolic-aldehyde resin components. At the end of that time period the press is cooled and the pressure is released.

A laminate made in this manner must then pass several physical tests, including impact resistance, abrasion resistance, blister resistance, ability to post-form, and resistance to boiling water. The present compositions comprising the modified phenolic-aldehyde resin provide laminates with low volatile emissions together with good physical properties.

In another embodiment, a laminate may be prepared for use in electrical grade applications. The catalysts for these resins are understood to be substantially free of metals for optimal dielectric properties, and may include ammonia, hexamethylenetetramine, triethylamine, triethanolamine, and other types of amines. Minimization of free metal and metal ions increase the dielectric breakdown voltage, wherein a current is passed through the laminate at an increasing rate and specified time until failure or arcing through the dielectric or dielectric laminate occurs.

In another embodiment, the modified phenolic-aldehyde resin compositions may be used as adhesives in the manufacture of consolidated wood products such as plywood, engineered lumber, oriented strand board, particle board, and the like. In the manufacture of adhesives, the modified phenolic-aldehyde resin may be prepared having an overall molar ratio of about 1.2 to about 3.5, specifically about 1.4 to about 2.5, more specifically about 1.8 to about 2.4 moles formaldehyde per mole phenol, and an alkaline catalyst level of about 0.25 to about 1.0 moles catalyst per mole phenol. The pH of the modified phenolic-aldehyde resin composition is typically from about 7.0 to about 12.0, specifically from about 10.0 to about 11.5. The modified phenolic-aldehyde resin composition comprises about 40 to about 70 wt % solids, specifically about 55 to about 65 wt % solids. Adhesive mixtures typically contain water, extenders, fillers, caustic, performance additives, and modified phenolic-aldehyde resin. Typical fillers and extenders include corn, wheat, soya, and other cereal flours and derivatives, finely ground nut shells, barks, and agricultural furfural waste residues. The adhesive mixtures are then applied to plywood veneers and the veneers are then combined in plies of three or more using a hot press to cure and bond the adhesive. Methods of applying adhesive to plywood and pressing are well known in the art.

An exemplary process for manufacture of a modified phenolic-aldehyde resin for laminates in accordance with this embodiment comprises forming a first aqueous reaction mixture by combining the phenol and the basic catalyst (at about 0.05 moles per mole of phenol), applying about 125 to about 72.5 torr (about 25 to about 27 inches Hg of vacuum) to the reactor, then feeding formaldehyde at an elevated temperature (e.g., about 75 to about 80° C.) over about a 50-minute period. The formaldehyde:phenol ratio may vary from about 1.05:1 to about 1.2:1. The resin is maintained at this temperature for about 70 minutes. Condensation proceeds at about 78 to about 80° C. to a projected endpoint having the desired free formaldehyde and phenol content. At this point in the process, free formaldehyde is about 0.10 wt % or less. An amount of urea-aldehyde condensate, specifically about 1 to about 16 wt % depending on the application, is added over about a 15 minute period, and the mixture is heated at about 78 to about 80° C. for about 120 minutes. The free formaldehyde may be about 0.05 to about 0.12% at this point in the process. Also at this point in the process, a compatible plasticizer may be added to the modified phenolic-aldehyde resin composition, and resulting mixture mixed at about 78 to about 80° C. for 10 minutes to disperse the plasticizer. The reaction is subsequently rapidly distilled, with the fraction collected distilling initially at a head temperature of about 60° C., and is run for about 1 to about 3 hours at a vacuum of about 15 to about 28 inches Hg of vacuum, or for a time sufficient to collect about 10 to about 30%, more specifically about 15 to about 25% of the total mass charged. The reaction is heated at about 60° C. to about 77° C. to an endpoint where the water tolerance of the modified phenolic-aldehyde resin composition is about 195% to about 205%. The heat is maintained for about 10 minutes beyond this endpoint, and the reaction is cooled to about 65° C. at about 125 torr (25 inches of Hg of vacuum). A viscosity-lowering compatible solvent, such as methanol, is charged subsurface in an amount sufficient to achieve the desired final viscosity, and the reaction is refluxed at about 50 to about 57° C. for about 10 minutes while mixing. The reaction is further cooled to about 40 to about 45° C., and acetic acid is added in an amount sufficient to adjust the pH of the modified phenolic-aldehyde resin composition from about 8 to about 9, and specifically about 8.3 to about 8.7, and then cooled to shipping or storage temperature (about 16 to about 22° C.). The refractive index of the modified phenolic-aldehyde resin composition may be between about 1.52 and about 1.53 as measured at 25° C.

The water tolerance of the modified phenolic-aldehyde resin composition for purposes of determining the reaction end point is determined by the following procedure a clean dry test tube with stir bar is place on a top pan balance and the Tare is balance to zero. Approximately 3-10 gram of resin sample is added to the test tube with disposable pipettes and the record weight according to Table 1:

TABLE 1

| Expected Water Tolerance | Sample Weight |
|---|---|
| 200% or less | 10 g |
| 300% | 7 g |
| 400% | 6 g |
| 500% | 5 g |
| 600% | 4 g |
| 700% | 3 g |

Next, 3-10 g of distilled or deionized water at 25.0° C.±0.1° C. is added to the test tube with disposable pipette. For viscous samples the water is added to the sample of modified phenolic-aldehyde resin composition before the sample cools. The sample is thoroughly mixed with water. For viscous samples, a test tube vortex mixer is used to agitate the sample vigorously thoroughly and completely mixed with water. If sample does not mix, it is placed in a water bath at 60° C. for 30 seconds, and vortex mixing is continued until mixing is complete. The test tube containing sample and any added water is then placed in a water bath at 25° C. on a stir plate for two minutes. Water is added to the sample from a disposable pipette while agitating until the sample begins to attain a cloudy appearance. The test end point (i.e., cloud point) occurs when small white alphanumeric characters on a black background, initially visible through the sample, can no longer be read when viewed through the sample. When the end point is reached, the test tube containing the sample is removed from the water bath, the outside surface of the test tube is thoroughly dried, and the test tube and sample are re-weighed. The water tolerance is then calculated using the following equation (note: the precision of the method is ±3%):

$$Water Tolerance ( in wt \% ) = \frac{( \begin{matrix}final sample wt . ( g ) - \\ initial sample wt . ( g )\end{matrix} ) \times 100 }{( initial sample wt ( g ) )}$$

In a particularly advantageous feature, the modified phenolic-aldehyde resin compositions may be used to manufacture products that maintain their desirable physical properties such as storage stability, moisture absorption, ability to post-form, mar resistance, and the like. In addition, these desired properties may be maintained at low emissions levels.

The urea-aldehyde condensate can also be used to prepare modified phenolic-aldehyde resins useful as saturating resins. Saturating resins are used to saturate paper for oil filters, overlay paper, and paint roller tube applications. Saturating resins are typically low formaldehyde-to-phenol ratio resole resins having about 0.8 to about 1.7 moles formaldehyde per mole phenol. The low mole ratio resins give the treated paper more flexibility for pleating before curing. Saturating resins are usually higher molecular weight resins that have less than 100% water tolerance. A distillation step is required and then the distilled resin is dissolved in an alcohol such as methanol, isopropanol, or ethyl alcohol.

The resin is then applied to base paper, usually in dip roller pans, and then the treated paper is heated in an oven to drive off solvent, resulting in “B” staged paper. The paper may then be rolled and provided to manufacturers to make articles for petroleum filtration (e.g., oil filters). The paper is pleated, cut, and cured in an oven. The cured paper has oil, temperature, water, and chemical resistant properties. Saturating resins for plywood overlays work in a similar way, except the treated paper is not pleated but is bonded onto plywood or other substrate with heat and pressure, thereby curing the resin.

Some high f/p mole ratio saturating resins, typically having an f/p ratio of 1.8:1 to 2.5:1 may be water soluble. Such resins, however, must be modified with a plasticizer such as a thermoplastic latex to give the treated paper pleatability, as they are typically high in cross link density and therefore are too brittle when cured in the absence of plasticizer. The advantage in waterborne resins are no emissions from solvent and due to higher F/P mole ratios there will be less emissions of free phenol.

Other uses for the urea-aldehyde condensate-modified phenol-formaldehyde resole resins (modified phenolic-aldehyde resins) include addition to abrasives coating resins as a modifier. Any phenol-formaldehyde resole resin used as an abrasive or friction binder may be so modified.

Foams as used, for example, in the manufacture of foam blocks for the floral industry, may also be produced using modified phenolic-aldehyde resin. Typically, phenol-formaldehyde resole resin foams range from about 1.7 to about 3.0 moles overall formaldehyde content per mole phenol. The urea-aldehyde condensate can be used to modify a phenol-formaldehyde resole resin to provide the desired f/p ratio in the modified phenolic-aldehyde resin. Generally phenol and formaldehyde are reacted with a base catalyst to form the base resin. The resin is then neutralized to a pH between about 6 and about 7 with an acid and water is then distilled from the resin to a low water content, approximately 5 to 15%. The resin typically has a high viscosity of about 2,000 to about 20,000 cPs. Alternatively, urea may be added to scavenge formaldehyde in these resins. A urea-aldehyde condensate may accordingly be added to the phenol-formaldehyde resole resin and urea premix. The important reactivity characteristic of these resins is controlled by such factors as the molecular weight, and the amounts of free monomer present.

In order to foam the resin, surfactants, and/or wetting agents are mixed into the resin to create bubbles within the resin. A low boiling liquid such as CFC, HCFC, pentane, or hexane is added to the mixture. A strong acid is added to the resin to initiate curing of the phenol-formaldehyde resole resin. This reaction generates heat causing the low boiling liquid to vaporize within the bubbles in the resin. As a result a foam is created from this mixture. Within about 10 minutes the foam rises to its maximum height and hardens when fully cured.

It is also possible to use the modified phenol-formaldehyde resole resins in the manufacture of acoustical ceiling tiles of the lay-in type. These are large rectangular interfelted cellulose or mineral fiber materials with a starch binder, perforated on the face side for absorption of sound. They are laid in hangers suspended from ceilings and are only supported by their edges. An anti-sag coating of a heat-cured thermosetting resin may be applied on the back side to prevent sag, which tends to occur under conditions of high temperature and humidity. The coating acts as a skin to hold the center of the tile in tension and provides the necessary support to keep the suspended tile flat. The modified phenol-formaldehyde resole resins may be combined with clay to form a coating that is applied to the ceiling tiles. Typical, but not limiting, resin-clay coating mixes are prepared with 4 wt % clay and 1 wt % resin in a 55 wt % solids aqueous mixture. The mixes are then catalyzed with the appropriate amount of a suitable catalyst such as ammonium sulfate to yield catalyzed resin-clay slurries.

Thus, in a particularly advantageous feature, the modified phenolic-aldehyde resins (modified with urea-aldehyde concentrate) disclosed herein have low free formaldehyde values throughout the manufacturing process and in the resulting compositions, up to and including manufacturing compositions, and shelf-life and physical properties that are lower than or at least comparable to unmodified phenol-formaldehyde resole resins and manufacturing compositions prepared therefrom. The manufacturing compositions may also be used to manufacture products that maintain their desirable physical properties such as color, tensile strength, moisture resistance, compression recovery, post-form, pleatability and the like. The following examples are for purposes of illustration and are not intended to limit the scope of the claimed invention.

### EXAMPLES

### Example 1

### Preparation of Urea-Aldehyde Condensate

An example of the preparation of a urea-formaldehyde condensate is as follows: A flask is charged with 124.5 g of a 50 wt % solution of formaldehyde, and the temperature of the solution is raised to about 60-70° C. The formaldehyde solution is adjusted to a pH of about 8.5 to about 9.2 by addition of about 0.7 g of 50 wt % sodium hydroxide in water. About 25 g of urea is then added, and the temperature is slowly raised to about 78° C. to about 82° C., and the temperature of the reaction is maintained at about 80° C. for a hold time of about 30 minutes. During this hold, the pH is checked about every 10 minutes, and is adjusted to maintain a reaction pH of about 7.2 or greater by addition of an effective amount of 25 wt % sodium hydroxide. After the hold time, the reaction is cooled to about 45° C. The reaction is distilled under vacuum, and 52.4 g of distillate is collected to give a refractive index endpoint for the condensate of 1.469 to 1.472. The amount of free formaldehyde is determined by sodium sulfite method to be 22 wt % of the total mass of the condensate.

### Example 2

### Preparation of Phenol-Formaldehyde Resole Resin Modified with Urea-Aldehyde Condensate

A phenol-formaldehyde resole resin modified with a urea-aldehyde condensate is prepared as follows. First, 1427.1 g (15.164 moles) phenol is added to a reaction vessel, followed by addition of 57.1 g (0.714 moles) of sodium hydroxide as a 50% aqueous solution, to provide 0.047 moles of catalyst per mole of phenol, and mixing was begun. Antifoam (0.03 g) is added. The reaction temperature is adjusted to 75° C., and heat is removed when this temperature is reached. Aqueous 50% formaldehyde solution (1004.7 grams, 16.73 moles) is then added at a controlled rate of about 20 g per minute over 50 minutes, until a temperature of 78-80° C. is obtained. At this point the quantity of formaldehyde charged to the reaction is 1.100 moles per mole of phenol. The mixture is allowed to react for a further 70 minutes while maintaining the temperature at 78-80° C. with vacuum reflux. At the end of this step in the process, the free (or unreacted) formaldehyde and phenol concentrations are 0.05% and 15.1%, respectively.

Next, 246.9 g of urea-formaldehyde condensate is added over a 15-minute period while maintaining the temperature at 78-80° C. This mixture is allowed to react for 120 minutes. Based on literature and observation, it appears that little reaction occurs between the urea and phenol species under the conditions maintained during the current process. Therefore, the resin at this stage may be composed of primarily of phenol-formaldehyde and, to a much lesser extent, urea-formaldehyde species. The free formaldehyde and free phenol content of the product at this stage are 0.15% and 10.25% by weight, respectively.

Next, the reaction is distilled to remove 526.6 g of distillate at a temperature of 55 to 66° C. using 86.7 torr (26.5 inches Hg of vacuum). The reaction is then heated to 77° C. and tested at about 15 minute intervals until a water tolerance of 190% is obtained at a refractive index of 1.5862 at 25° C. (about 60 minutes hold time). During this hold at 77° C., it is believed that the various components in the mixture continue to undergo polymerization. In this test, water is added to a sample of resin until a haze point is obtained. A specific ratio of water to resin is targeted as the endpoint. In this case, a haze point at a ratio of two parts water to one part resin is targeted.

Vacuum reflux is used to cool the reaction to 65° C., and 498.1 g methanol is added to give a viscosity of about 137 cPs. The reaction is mixed for 10 minutes at 50-57° C., then cooled to 40-45° C. Glacial acetic acid (21.4 g) is added to adjust the pH to 8.49, and the resin is cooled to 16-24° C. The methanol is added as a nonreactive diluent to lower the viscosity of the final resin product for ease of handling, to aid in the application of the resin to the paper substrate, and to reduce the amount of energy and time required to dry the impregnated paper. Acetic acid decreases the pH to give a pH dependent target reactivity rate for the final product. The physical properties of the final resin are shown in Table 2 below:

TABLE 2

| Property | Test Result |
|---|---|
| Nonvolatiles (solids, %) | 64.6 |
| Viscosity (cPs) | 137 |
| pH | 8.49 |
| Free Phenol (%) | 8.6 |
| Free Formaldehyde (%) | 0.05 |

### Example 3

### Preparation of Novolak Plasticizer

A reactor is charged with 1650.0 g phenol and 24.0 g of oxalic acid, and the mixture is heated to 100° C. with stirring. A 50% aqueous solution of formaldehyde (778.5 g) is fed into the reactor with stirring over 60 minutes, at a feed rate of about 13 g per minute. After formaldehyde addition is complete, the temperature is maintained for an additional 60 minutes to increase the degree of condensation of the resin. The reaction is distilled at atmospheric pressure to 160° C. to remove 673.5 g of distillate. Distillation is continued under about 38 torr (28.5 inches of vacuum) to a temperature of 190° C., and a second cut of 279.0 g of distillate is collected, to give a free phenol level of less than 0.7%. While hot, the resulting novolak resin is poured onto a pan to cool. The resin is allowed to cool, and is then broken up into flake form. The flake resin is used as is in subsequent steps. The ratio of formaldehyde to free phenol in the final novolak resin is 0.74:1. The properties of the resin are provided in Table 3, below.

TABLE 3

| Property | Test Result |
|---|---|
| Nonvolatiles (solids, %) | 99.7 |
| Free Phenol (%) | 0.3 |
| Free Formaldehyde (%) | None detected |

### Example 4

### Preparation of Phenol-Formaldehyde Resole Resin Modified with Urea-Aldehyde Condensate and Novolak Plasticizer

A phenol-formaldehyde resole resin modified with a urea-aldehyde condensate is prepared as follows. First, 47.0 g (0.499 moles) phenol is added to a reaction vessel, followed by addition of 1.9 g (0.0238 moles) of 50% sodium hydroxide aqueous solution, to provide 0.0476 moles of catalyst per mole of phenol, and mixing was begun. The reaction temperature is adjusted to 75° C., and heat is removed when this temperature is reached. Aqueous 50% formaldehyde solution (33.0 grams, 0.549 moles) is then added at a controlled rate of 0.7 g per minute over 50 minutes, until a temperature of 80° C. is obtained. At this point the quantity of formaldehyde charged to the reaction is 1.10 moles per mole of phenol. The mixture is allowed to react for a further 70 minutes while maintaining the temperature at 80° C. with vacuum reflux.

Next, 8.1 g of the urea-aldehyde condensate is added over a 15-minute period while maintaining the temperature at 80° C. This mixture is allowed to react for 120 minutes. The temperature is reduced to 60-65° C. and the reaction is distilled. A total of 17.3 g of distillate is collected at 89 torr (26.5 inches of Hg of vacuum). The reaction is then heated to 75-78° C. and reacted until a 190% water tolerance is obtained.

The reaction is cooled to 65° C., nitrogen is applied, and 19.6 g methanol is added. The reaction is mixed for 10 minutes at 65° C., then cooled to 50-55° C. The novolak from Example 3 (7.0 g) is added to the reaction, and the reaction is agitated for 30 minutes to ensure homogeneity. Glacial acetic (0.4 g) acid is added, and the modified phenolic-aldehyde resin composition is cooled to 16-24° C. The physical properties of the final resin are provided in Table 4, below. The resulting modified phenolic-aldehyde resin composition may be used in the preparation of resin impregnated papers for oil filters.

TABLE 4

| Property | Test Result |
|---|---|
| Nonvolatiles (solids, %) | 64.0 |
| Viscosity (cPs) | 240 |
| Refractive Index | 1.5270 |
| Free Phenol (%) | 8.0 |
| Free Formaldehyde (%) | 0.05 |

### Example 5

### Preparation of Phenol-Formaldehyde Resole Resin Modified with Urea-Aldehyde Condensate and BPA Plasticizer

A phenol-formaldehyde resole resin modified with a urea-aldehyde condensate is prepared as follows. First, 51.1 g (0.544 moles) phenol is added to a reaction vessel, followed by addition of 2.0 g (0.025 moles) of 50% sodium hydroxide aqueous solution, to provide 0.046 moles of catalyst per mole of phenol, and mixing was begun. Antifoam (0.001 g) is added. The reaction temperature is adjusted to 75° C., and heat is removed when this temperature is reached. Aqueous 50% formaldehyde solution (36.0 grams, 0.60 moles) is then added at a controlled rate of 0.7 g per minute over 50 minutes, until a temperature of 78-80° C. is obtained. At this point the quantity of formaldehyde charged to the reaction is 1.103 moles per mole of phenol. The mixture is allowed to react for a further 70 minutes while maintaining the temperature at 78-80° C. with vacuum reflux. At the end of this step in the process, the free (or unreacted) formaldehyde and phenol concentrations are 0.0% and 19.3%, respectively.

Next, 8.8 g of the urea-aldehyde condensate (0.176 moles formaldehyde; 0.037 moles urea) is added over a 15-minute period while maintaining the temperature at 78-80° C. This mixture is allowed to react for 120 minutes. The free formaldehyde and free phenol content of the product at this stage are 0.1 and 12.2% by weight, respectively. Next, 2.6 g bisphenol A (BPA) is added as a plasticizer and mixed for 10 minutes, and the reaction is distilled to remove 18.9 g of distillate at a temperature of 60-65° C. using 112 to 86.7 torr (25.5 to 26.5 inches Hg of vacuum). The reaction is then heated to 75° C. and reacted until a water tolerance of about 195 to about 200% is obtained. The final molar ratio of formaldehyde:urea:phenol is 1.33:0.07:1.00.

Vacuum reflux is used to cool the reaction to 65° C., and 17.8 g methanol is added to give a viscosity of about 120 to about 170 cPs at a refractive index of about 1.520 to about 1.531. The reaction is mixed for 10 minutes at 50-57° C., then cooled to 40-45° C. Glacial acetic (0.5 g) acid is added to adjust the pH to 8.3-8.7, and the resin is cooled to 16-24° C. The physical properties of the final resin are provided in Table 5, below.

TABLE 5

| Property | Test Result |
|---|---|
| Nonvolatiles (solids, %) | 65.2 |
| Viscosity (cPs) | 142 |
| pH | 8.5 |
| Free Phenol (%) | 9.2 |
| Free Formaldehyde (%) | 0.05 |

### Example 6

### Preparation of Phenol-Formaldehyde Resole Resin Modified with Urea-Aldehyde Condensate and Gum Rosin Plasticizer

A phenol-formaldehyde resole resin modified with a urea-aldehyde condensate is prepared as follows. First, 50.6 g (0.538 moles) phenol is added to a reaction vessel, followed by addition of 2.0 g (0.025 moles) of 50% sodium hydroxide aqueous solution, to provide 0.0465 moles of catalyst per mole of phenol, and mixing was begun. The reaction temperature is adjusted to 75° C., and heat is removed when this temperature is reached. Aqueous 50% formaldehyde solution (35.6 grams, 0.593 moles) is then added at a controlled rate of about 0.7 g per minute over 50 minutes, until a temperature of 80° C. is obtained. At this point the quantity of formaldehyde charged to the reaction is 1.10 moles per mole of phenol. The mixture is allowed to react for a further 70 minutes while maintaining the temperature at 80° C. with vacuum reflux.

Next, 8.8 g of the urea-aldehyde condensate is added over a 15-minute period while maintaining the temperature at 78-80° C. This mixture is allowed to react for 120 minutes. The temperature is reduced to 55-60° C. and the reaction is distilled. A total of 18.7 g of distillate is collected at a vacuum of 99.5 torr (26.0 inches Hg of vacuum). The reaction is then heated to 75° C. and reacted until a 190-200% water tolerance is obtained.

The reaction is cooled to 65° C., nitrogen is applied, and 17.7 g methanol is added. The reaction is mixed for 10 minutes at 65° C., then cooled to 50-55° C. Gum rosin (3.2 g) is added to the reaction, and the reaction is agitated for 30 minutes to ensure homogeneity. The reaction is cooled to 40-45° C., and glacial acetic (0.5 g) acid is added, and the modified phenolic-aldehyde resin composition is cooled to 25° C. The final ratio of formaldehyde to phenol in the modified phenolic-aldehyde resin composition is 1.43:1. Physical properties of the final resin are provided in Table 6, below.

TABLE 6

| Property | Test Result |
|---|---|
| Nonvolatiles (solids, %) | 67.0 |
| Viscosity (cPs) | 200 |
| pH | 8.0 |
| Free Phenol (%) | 8.2 |
| Free Formaldehyde (%) | 0.05 |

### Example 7

### Preparation of Phenol-Formaldehyde Resole Resin Modified with Urea-Aldehyde Condensate and Diethylene Glycol Plasticizer

A phenol-formaldehyde resole resin modified with a urea-aldehyde condensate is prepared as follows. First, 51.0 g (0.542 moles) phenol is added to a reaction vessel, followed by addition of 2.0 g (0.025 moles) of 50% sodium hydroxide aqueous solution, to provide 0.0460 moles of catalyst per mole of phenol, and mixing was begun. The reaction temperature is adjusted to 75° C., and heat is removed when this temperature is reached. Aqueous 50% formaldehyde solution (35.9 grams, 0.598 moles) is then added at a controlled rate of about 0.7 g per minute over 50 minutes, until a temperature of 80° C. is obtained. At this point the quantity of formaldehyde charged to the reaction is 1.10 moles per mole of phenol. The mixture is allowed to react for a further 70 minutes while maintaining the temperature at 78-80° C. with vacuum reflux.

Next, 8.8 g of the urea-aldehyde condensate is added over a 15-minute period while maintaining the temperature at 78-80° C. This mixture is allowed to react for 120 minutes. The temperature is reduced to 55-60° C. and the reaction is distilled. A total of 18.8 g of distillate is collected at a vacuum of 86.7 torr (26.5 inches Hg of vacuum). The reaction is then heated to 75° C. and reacted until a 190-200% water tolerance is obtained.

The reaction is cooled to 65° C., nitrogen is applied, and 17.8 g methanol is added. The reaction is mixed for 10 minutes at 65° C., then cooled to 50-60° C. Diethylene glycol (2.5 g) is added to the reaction, and the reaction is agitated for 10 minutes to ensure homogeneity. The reaction is cooled to 4045° C., and glacial acetic (0.8 g) acid is added, and the modified phenolic-aldehyde resin composition is cooled to 25° C. The final ratio of formaldehyde to phenol in the modified phenolic-aldehyde resin composition is 1.43:1. Physical properties of the final resin are provided in Table 7, below.

TABLE 7

| Property | Test Result |
|---|---|
| Nonvolatiles (solids, %) | 65.0 |
| Viscosity (cPs) | 140 |
| pH | 8.5 |
| Free Phenol (%) | 8.5 |
| Free Formaldehyde (%) | 0.05 |

### Example 8

### Preparation of Phenol-Formaldehyde Resole Resin Modified with Urea-Aldehyde Condensate and Sorbitol Plasticizer

A phenol-formaldehyde resole resin modified with a urea-aldehyde condensate is prepared as follows. First, 50.7 g (0.539 moles) phenol is added to a reaction vessel, followed by addition of 2.0 g (0.025 moles) of 50% sodium hydroxide aqueous solution, to provide 0.0464 moles of catalyst per mole of phenol, and mixing was begun. The reaction temperature is adjusted to 75° C., and heat is removed when this temperature is reached. Aqueous 50% formaldehyde solution (35.7 grams, 0.594 moles) is then added at a controlled rate of about 0.7 g per minute over 50 minutes, until a temperature of 80° C. is obtained. At this point the quantity of formaldehyde charged to the reaction is 1.10 moles per mole of phenol. The mixture is allowed to react for a further 70 minutes while maintaining the temperature at 78-80° C. with vacuum reflux.

Next, 8.8 g of the urea-aldehyde condensate is added over a 15-minute period while maintaining the temperature at 78-80° C. This mixture is allowed to react for 120 minutes. The temperature is reduced to 55-60° C. and the reaction is distilled. A total of 18.8 g of distillate is collected at a vacuum of 86.7 torr (26.5 inches Hg of vacuum). The reaction is then heated to 75° C. and reacted until a 190-200% water tolerance is obtained.

The reaction is cooled to 65° C., nitrogen is applied, and 17.7 g methanol is added. The reaction is mixed for 10 minutes at 65° C., then cooled to 50-60° C. Sorbitol (3.1 g) is added to the reaction, and the reaction is agitated for 30 minutes to ensure homogeneity. The reaction is cooled to 40-45° C., and glacial acetic (0.8 g) acid is added, and the modified phenolic-aldehyde resin composition is cooled to 25° C. The final ratio of formaldehyde to phenol in the modified phenolic-aldehyde resin composition is 1.43:1. Physical properties of the final resin are provided in Table 8, below.

TABLE 8

| Property | Test Result |
|---|---|
| Nonvolatiles (solids, %) | 65.1 |
| Viscosity (cPs) | 172 |
| pH | 8.5 |
| Free Phenol (%) | 8.4 |
| Free Formaldehyde (%) | 0.05 |

### Example 9

### Preparation of a Comparative Example

A phenol-formaldehyde resole resin without a urea-aldehyde condensate is prepared as follows. First, 1200.0 g (12.75 moles) phenol is added to a reaction vessel, followed by addition of 48.0 g (0.6 moles) of sodium hydroxide as a 50% aqueous solution, to provide 0.047 moles of catalyst per mole of phenol, and mixing was begun. Antifoam (0.03 g) is added. The reaction temperature is adjusted to 75° C., and heat is removed when this temperature is reached. Aqueous 50% formaldehyde solution (1095.6 grams, 18.24 moles) is then added at a controlled rate of about 20 g per minute over 50 minutes, until a temperature of 78-80° C. is obtained. At this point the quantity of formaldehyde charged to the reaction is 1.43 moles per mole of phenol. The mixture is allowed to react for a further 120 minutes while maintaining the temperature at 78-80° C. with vacuum reflux. At the end of this step in the process, the free (or unreacted) formaldehyde and phenol concentrations are 0.25% and 9.65%, respectively. The water tolerance is 200%.

Next, the reaction is distilled to remove 563 g of distillate at a temperature of 49 to 66° C. using 86.7 torr (26.5 inches Hg of vacuum). A water tolerance of 190% is obtained.

If needed, vacuum reflux is used to cool the reaction to 65° C., and 420 g methanol is added to give a viscosity of about 105 cPs. The reaction is mixed for 10 minutes at 50-57° C., then cooled to 40-45° C. Glacial acetic acid (16.0 g) is added to adjust the pH to 8.38, and the resin is cooled to 16-24° C. The physical properties of the final resin are shown in Table 9 below.

TABLE 9

| Property | Test Result |
|---|---|
| Nonvolatiles (solids, %) | 64.3 |
| Viscosity (cPs) | 105 |
| pH | 8.38 |
| Free Phenol (%) | 8.72 |
| Free Formaldehyde (%) | 0.20 |

As compared to Example 2, Table 2, the free formaldehyde of Example 9 is 0.15% lower for about the same free phenol and water tolerance endpoint when using the same molar amount of sodium hydroxide based on phenol.

The singular forms “a”, “an”, and “the” include plural referents unless the context clearly dictates otherwise. The endpoints of all ranges reciting the same characteristic or referring to the quantity of the same component are independently combinable and inclusive of the recited endpoint. All cited patents, patent applications, and other references are incorporated herein by reference in their entirety.

While typical embodiments have been set forth for the purpose of illustration, the foregoing descriptions should not be deemed to be a limitation on the scope herein. Accordingly, various modifications, adaptations, and alternatives may occur to one skilled in the art without departing from the spirit and scope herein.

What is claimed is:

1. A method for the manufacture of a modified phenolic-aldehyde resin composition, comprising:
reacting a base with a phenolic compound to produce a phenolate medium;
adding an aldehyde source to the phenolate medium wherein the initial mole ratio of aldehyde to phenolic compound is about 0.7:1 to about 1.4:1;
heating the aldehyde source and phenolate medium for a time and at a temperature sufficient to yield an aldehyde-phenolate medium with a level of free aldehyde of less than about 0.5% of the total mass on a liquids basis;
adding a urea-aldehyde condensate to the aldehyde-phenolate medium; and
condensing the resulting urea-aldehyde-phenolate medium,
wherein the modified phenolic-aldehyde resin is not infinitely dilutable in water.

2. The method of claim 1 wherein heating the aldehyde source and phenolic compound is without an added aldehyde scavenger.

3. The method of claim 1 where the base is a primary, secondary, or tertiary amine; ammonium, alkylammonium, or arylalkylammonium hydroxide; ammonium or alkylammonium carbonate; alkali metal hydroxide; alkali metal carbonate; alkaline earth metal hydroxide; alkaline earth metal carbonate; transition metal hydroxide; transition metal carbonate; or a combination comprising at least one of the foregoing bases.

4. The method of claim 1 where the molar ratio of base to phenolic compound is about 0.01:1 to about 0.6:1.

5. The method of claim 1 wherein the phenolic compound comprises a substituted monophenolic compound, an unsubstituted monophenolic compound, a substituted dihydric phenol compound, an unsubstituted dihydric phenol compound, a substituted polycyclic monophenol, a unsubstituted polycyclic monophenols, a phenolic oligomer, or a combination comprising at least one of the foregoing compounds.

6. The method of claim 1 where the aldehyde source is a formaldehyde, acetaldehyde, propionaldehyde, furfuraldehyde, glutaraldehyde, benzaldehyde, paraformaldehyde, formalin, or a combination comprising at least one of the foregoing.

7. The method of claim 1 wherein the aldehyde source is formaldehyde and the phenolic compound is phenol.

8. The method of claim 1 where the temperature of heating the aldehyde and phenolate medium is about 50 to about 100° C.

9. The method of claim 1 where the aldehyde of the urea-aldehyde condensate is formaldehyde, acetaldehyde, propionaldehyde, furfuraldehyde, glutaraldehyde, benzaldehyde, or a combination comprising at least one of the foregoing aldehydes.

10. The method of claim 1 where the molar ratio of aldehyde to urea in the urea-aldehyde condensate is about 3:1 to about 6:1.

11. The method of claim 1 where the weight ratio of urea-aldehyde condensate to the aldehyde-phenolate medium is about 1:99 to about 50:50.

12. The modified phenolic-aldehyde resin composition of claim 1 where the final molar ratio of aldehyde to phenolic compound in the modified phenolic-aldehyde resin is about 0.7:1 to about 4.5:1.

13. The method of claim 1 further comprising adding a plasticizer to the modified phenolic-aldehyde resin composition.

14. The method of claim 13 where a plasticizer is wood rosin, diethyleneglycol, sorbitol, bisphenol A, bisphenol F, phenolic compound-aldehyde novolak resins, ethylene glycol, oligomeric ethylene glycol derivatives, propylene glycol, oligomeric propylene glycol derivatives, sugars, sugar alcohols, guanamines, rosins, derivatized phenols, phenolic novolac resin or a combination comprising at least one of the foregoing.

15. The method of claim 13, where the plasticizer comprises about 0.1 to about 15.0 wt % of solids of the modified phenolic-aldehyde resin composition.

16. The method of claim 1 where the modified phenolic-aldehyde resin composition has a viscosity of about 80 to about 20,000 cPs.

17. The method of claim 1 where the modified phenolic-aldehyde resin composition has a pH of about 5.5 to about 10.0.

18. A modified phenolic-aldehyde resin comprising the reaction product of the combination of:
a phenolic compound;
about 0.01 to about 1.0 moles of base catalyst per mole of phenolic compound;
an aldehyde, wherein the initial molar ratio of aldehyde:phenolic compound is about 0.7:1 to about 1.4:1; and
a urea-aldehyde condensate, the combination being reacted at a temperature of about 70 to about 90° C. for a time effective to form a modified phenolic-aldehyde resin that is not infinitely dilutable in water, and wherein the final molar ratio of aldehyde:phenolic compound in the modified phenolic-aldehyde resin is about 0.7:1 to about 4.5:1.

19. An article comprising the modified phenolic-aldehyde resin of claim 18.

20. A composition comprising and additive, and
a modified phenolic-aldehyde resin composition comprising the reaction product of the combination of:
a phenolic compound;
about 0.01 to about 1.0 moles of base catalyst per mole of phenolic compound;
an aldehyde, wherein the molar ratio of aldehyde:phenolic compound is about 0.7:1 to about 1.4:1; and
a urea-aldehyde condensate, the combination being reacted at a temperature of about 70 to about 90° C. for a time effective to form a modified phenolic-aldehyde resin that is not infinitely dilutable in water.
